(19) United States
(12) Patent Application Publication
(10) Pub. No.: US 2013/0047906 A1
(43) Pub. Date: Feb. 28, 2013

(54) Car device for preventing flood damage

(71) Applicant: Wen-Ching Kuo, Tainan (TW)

(72) Inventor: Wen-Ching Kuo, Tainan (TW)

(21) Appl. No.: 13/199,335

(22) Filed: Aug. 29, 2011

(51) Int. Cl. B63B 35/00; B60R 99/00

(52) U.S. Cl. 114/123

(57) ABSTRACT

This invention relates to a car device for preventing flood damage, it uses the material of better ductility, wear resistant and waterproof to manufacture the cover which divided into upper and lower parts corresponded each other, wherein several airbag rooms are formed by gluing on each side edge with machine; before gluing with machine, an airbag is set in each airbag room, and each airbag room is dense impervious, an air inlet of each airbag is protruding out of the cover, so thus the joint of the air inlet and the cover is also dense impervious; for example, put the cover under a car and set the air through the air inlet to the airbag to inflate the cover and keep the car in high location, thus when the flood comes, the car can float on the water and avoid flood damage.

### BACKGROUND OF THE INVENTION

1. Field of the Invention

This invention relates to a car device for preventing floods damage, it stays the car in high location when the flood comes and prevent the car from flood damage. Moreover, the present invention can be used as a life-saving vehicle, a shelter from the weather or a camping mattress.

2. Description of the Related Art

Global warming strengthens the global water cycle, and thus it may increase the floods, droughts and other extreme weather events. Half of the world's population lives within 100 kilometers of the coast, therefore, when a few meters of sea level rise, the low-lying areas may suffer flood damage, and serious flooding increasingly occurs around the world. In the past, when flood occurs, the cars stopped at the roadside were damaged; furthermore, the cost for repair is substantial. When the flood occurs, cars in low-lying areas are drowned and people are often waiting for rescue from drowning incident. Due to the reasons mentioned above, the present invention is to resolve these problems.

### SUMMARY

This invention relates to a car device for preventing flood damage, it uses the material of better ductility, wear resistant and waterproof to manufacture the cover which divided into upper and lower parts which corresponded each other, wherein several airbag rooms are formed by gluing on each side edge with machine; before gluing with machine, an airbag is set in each airbag room, and each airbag room is dense impervious, an air inlet of each airbag is protruding out of the cover, so thus the joint of the air inlet and the cover is also dense impervious; for example, put the cover under a car and set the air through the air inlet to the airbag to inflate the cover and keep the car in high location, thus when the flood comes, the car can float on the water and avoid flood damage.

The present invention as foregoing mentioned has the advantages as following:

First, when the flood occurs, the cars stopped at the roadside can be stayed in high location and floated on the water through the present invention to protect the engine and the circuit of the cars.

Second, in the low-lying flooding areas, the present invention can be used as a life-saving vehicle to prevent from drowning.

Third, the present invention can be inflated and used as a camping mattress when going camping.

Forth, the present invention can be inflated and used as a shelter from the weather when going camping.

Fifth, the present invention can be deflated and folded and store in the boot of a car.

### BRIEF DESCRIPTION OF THE DRAWINGS

FIG. 1 is a perspective view of a preferred embodiment of the present invention.

FIG. 2 is a schematic view of a preferred embodiment being inflated of the present invention.

FIG. 3 is a side view of a preferred embodiment being inflated of the present invention.

FIG. 4 is a schematic view of a preferred embodiment being stored of the present invention.

FIG. 5 is a schematic view of a preferred embodiment putting under a car without being inflated of the present invention.

FIG. 6 is a schematic view of a preferred embodiment putting under a car being inflated of the present invention.

FIG. 7 is a schematic drawing illustrating the example for the combination of the cover and the component cover of the present invention.

FIG. 8 is a schematic drawing illustrating the example for the life-saving vehicle of the present invention.

FIG. 9 is a schematic drawing illustrating the example for the shelter from the weather of the present invention.

### DETAILED DESCRIPTION OF THE INVENTION

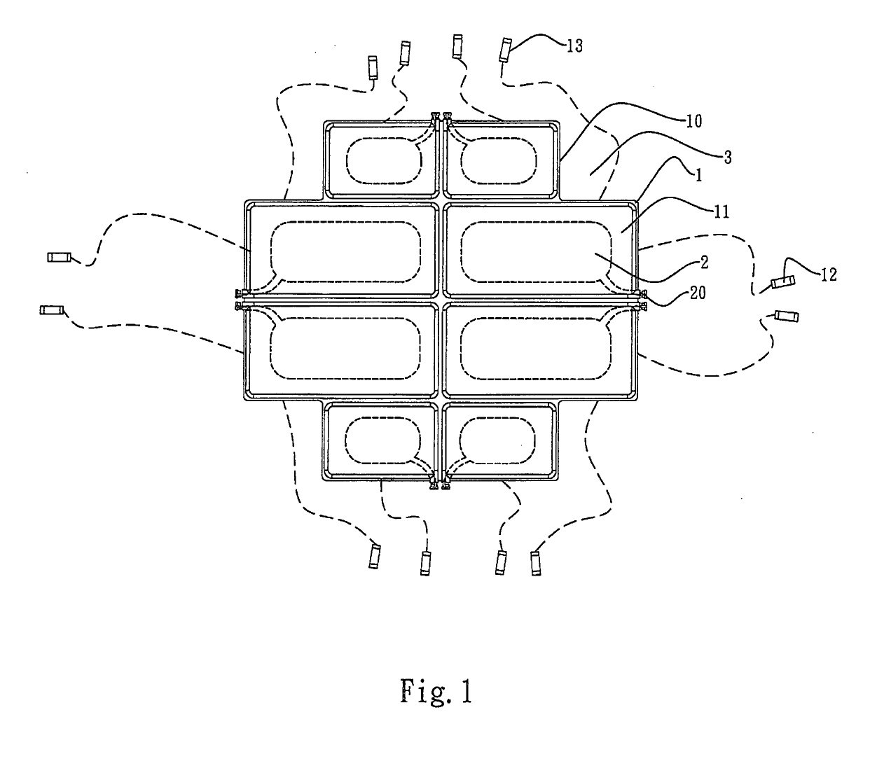

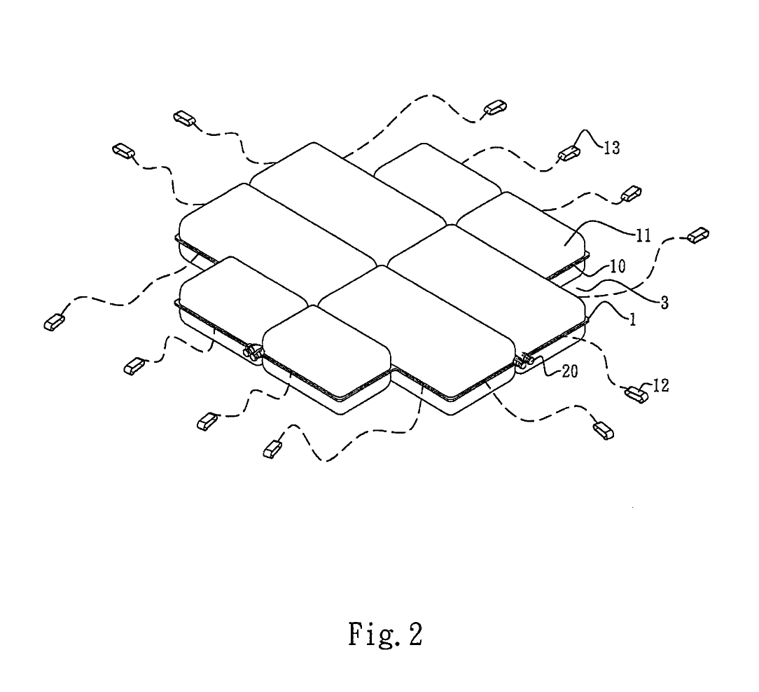

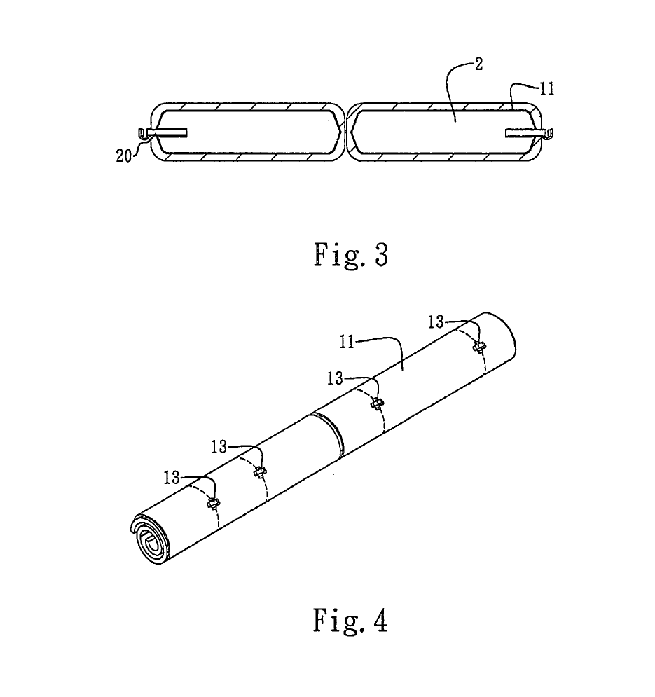

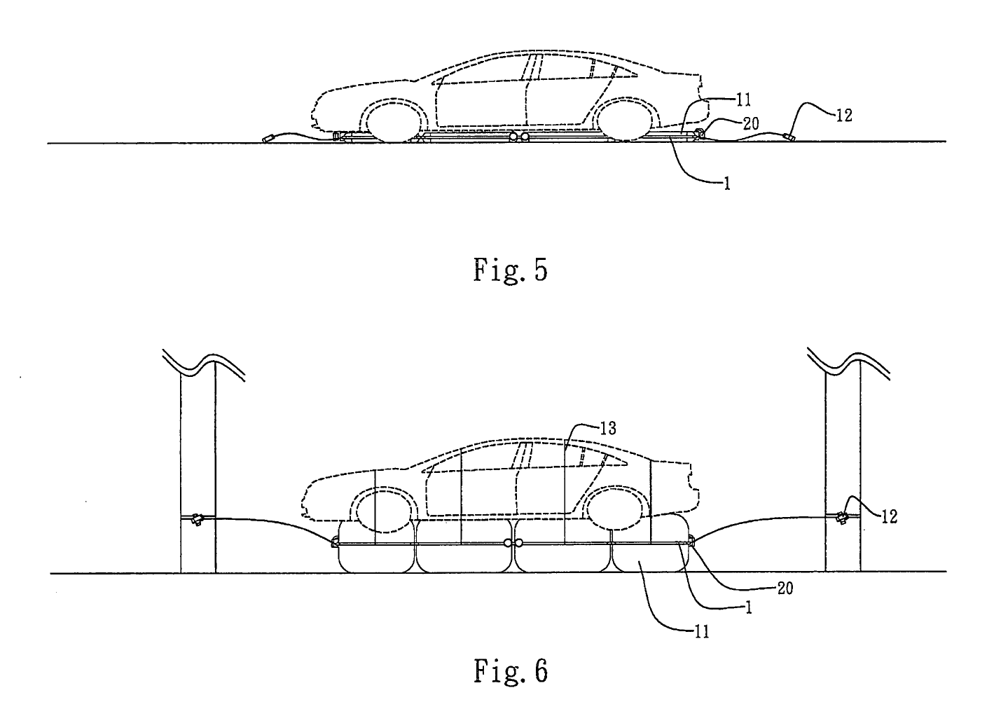

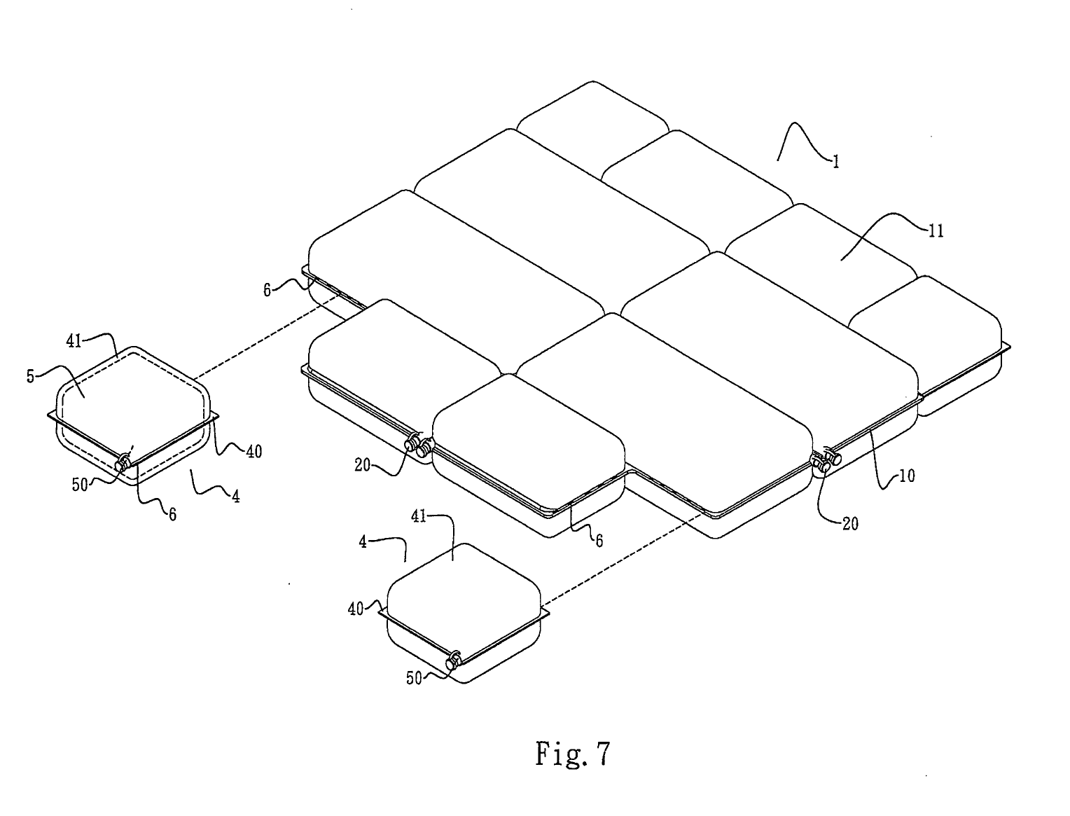

Referring to FIGS. 1 through 3, the invention relates to a car device for preventing flood damage, it uses the material of better ductility, wear resistant and waterproof to manufacture the cover (1) which divided into upper and lower parts corresponded each other and a gap (3) is on each corner. Several airbag rooms (11) are formed by gluing on each side edge (10) with machine. Before gluing with machine, an airbag (2) is set in each airbag room (11); each airbag room (11) is dense impervious. An air inlet (20) of each airbag (2) is protruding out of the cover (1), so thus the joint of the air inlet (20) and the cover (1) is also dense impervious. As shown in FIGS. 5 and 6, put the present invention under a car and let the four wheels of the car on each gap (3) of the cover (1), inflate the airbag (2) of the cover (1), and the car will be propped high up. Meanwhile, the chassis of the car leans against the surface of the cover (1) and will not be hung up in the air. Therefore, the cover (1) will not be broken by uneven pressure. Moreover, the quantity of the airbag rooms (11) may depend on the weight of the cars to be arranged.

As shown in FIGS. 1 through 3 and FIGS. 5 and 6, a fixed rope (12) is set on each front and rear end of the cover (1) to fasten large immobile object and therefore to prevent the vehicle from floating with the water flow. A lasso (13) with flexibility and constriction set on left and right end of the cover is to fasten the vehicle tightly, so that the vehicle may not be loose from the cover.

As shown in FIG. 4, the cover can be folded and stored in the boot of a car when it is not used.

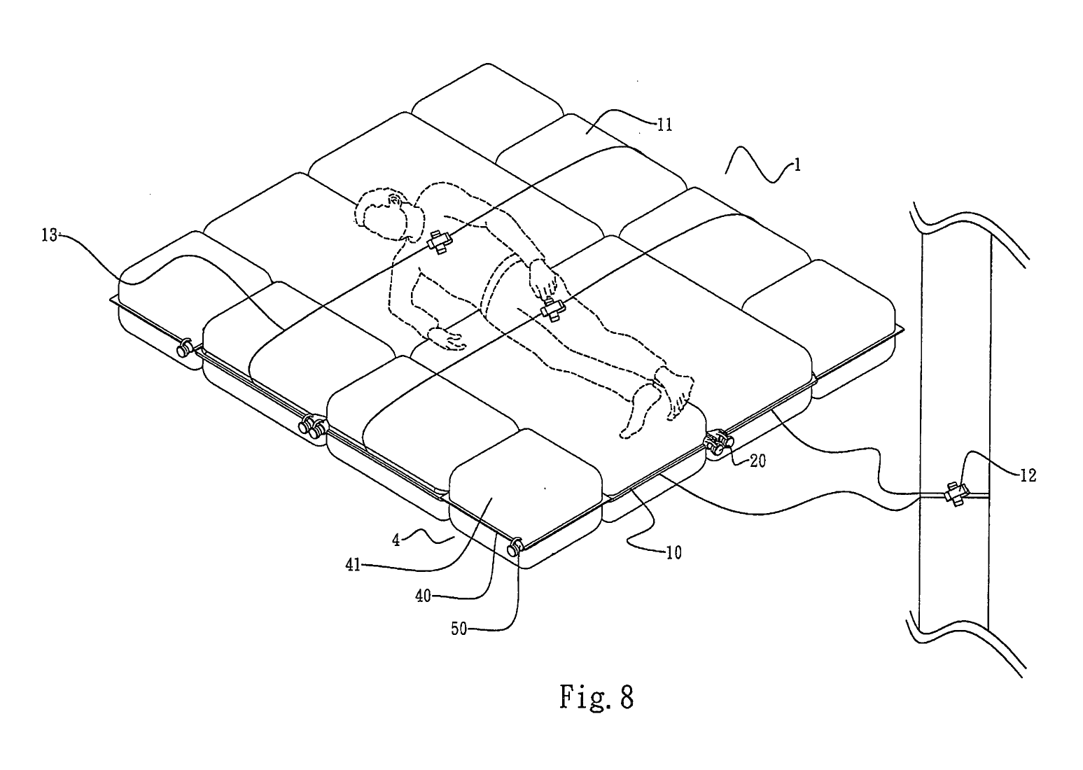

As shown in FIGS. 7 and 8, a component cover (4) can be set on each four gap (3) on each side edge (10) of the cover (1) with Velcro (6) to form the component cover (4) and the cover (1) a whole bed shape. An airbag room (41) of the component cover (4) is formed by gluing on each side edge (40) with machine. Set Velcro (6) on side edge (40) of the component cover (4), and an airbag (5) is set in the airbag room (41). An air inlet (50) of the airbag (5) is protruding out of the component cover (4) to inflate and deflate the component cover (4), when the low-lying areas suffer flood damage, the present invention can be used as a life-saving vehicle to prevent from drowning. Furthermore, a fixed rope (12) is set on each front and rear end of the cover (1) to fasten large immobile object, such as a trunk, to prevent the inflated cover (1) and the component cover (4) float away. And a lasso (13) set on left and right end of the cover (1) can be fastened on human body to prevent from drowning. The inflated cover (1) is also can be used as a camping mattress or a seat when going out camping.

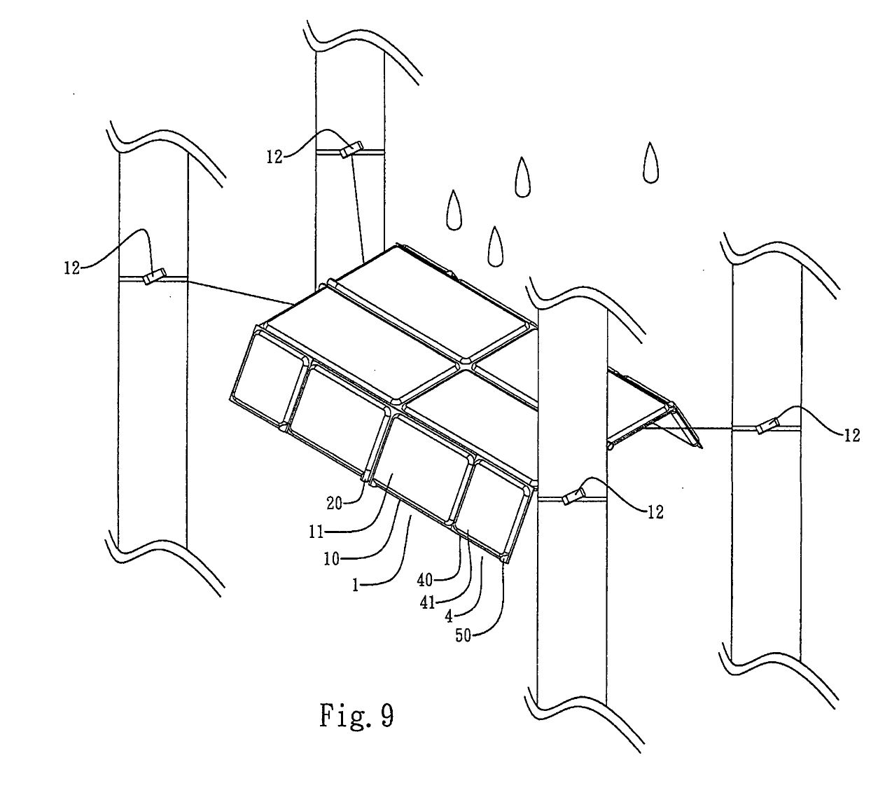

As shown in FIG. 9, the deflated cover (1) and component cover (4) which combined together can be used as a shelter from the weather when going camping, wherein the fixed rope (12) and the lasso (13) can be fastened on the trunk.

Although specific embodiments have been illustrated and described, it will be obvious to those skilled in the art that various modifications may be made without departing from what is intended to be limited solely by the appended claims.

I claim:

1. A car device for preventing flood damage, it uses the material of better ductility, wear resistant and waterproof to manufacture a cover which divided into upper and lower parts corresponded each other, wherein several airbag rooms are formed by gluing on each side edge with machine; before gluing with machine, an airbag is set in each airbag room, and each airbag room is dense impervious, an air inlet of each airbag is protruding out of said cover, so thus the joint of said air inlet and said cover is also dense impervious.

2. A car device for preventing flood damage as recited in claim 1, wherein a fixed rope is set on each front and rear end of said cover.

3. A car device for preventing flood damage as recited in claim 1, wherein a lasso is set on each left and right end of said cover.

4. A car device for preventing flood damage as recited in claim 1, wherein a component cover can be fitted on said side edge of each gap of said cover with Velcro.

5. A car device for preventing flood damage as recited in claim 4, wherein an airbag room of said component cover is formed by gluing on each side edge with machine; set Velcro on side edge of said component cover, an airbag is set in said airbag room, an air inlet of said airbag is protruding out of said component cover.
